(19) United States
(12) Patent Application Publication
(10) Pub. No.: US 2020/0057974 A1
(43) Pub. Date: Feb. 20, 2020

(54) INFORMATION PROCESSING SYSTEM AND SELF-PROPELLED MOBILE APPARATUS

(71) Applicant: FUJI XEROX CO., LTD., Tokyo (JP)

(72) Inventors: Tetsuya KOBAYASHI, Kanagawa (JP); Mariko MIYAZAKI, Kanagawa (JP); Hajime KAJIYAMA, Kanagawa (JP); Akira ICHIKAWA, Kanagawa (JP); Xiongfan JIN, Kanagawa (JP); Hideki FUJIMOTO, Kanagawa (JP); Kunitoshi YAMAMOTO, Kanagawa (JP)

(73) Assignee: FUJI XEROX CO., LTD., Tokyo (JP)

(21) Appl. No.: 16/537,630

(22) Filed: Aug. 12, 2019

(30) Foreign Application Priority Data
Aug. 20, 2018 (JP) 2018-154193

(51) Int. Cl. G06Q 10/06; G05D 1/02; G06Q 30/06

(52) U.S. Cl. CPC G06Q 10/06316; G06Q 30/0645; G05D 1/0287

(57) ABSTRACT

An information processing system includes an obtaining unit that obtains settings of a scheduled time and a scheduled place at which a first user is to use the self-propelled mobile apparatus, the scheduled time and the schedule place being set by the first user, a reception unit that receives at least one instruction of a movement for the self-propelled mobile apparatus, the at least one instruction being given by a second user, and a control unit that, if execution of the instructed movement would prevent the scheduled use of the self-propelled mobile apparatus from taking place at the scheduled place from the scheduled time, causes the self-propelled mobile apparatus not to execute the instructed movement.

### CROSS-REFERENCE TO RELATED APPLICATIONS

This application is based on and claims priority under 35 USC 119 from Japanese Patent Application No. 2018-154193 filed Aug. 20, 2018.

### BACKGROUND

### (i) Technical Field

The present disclosure relates to an information processing system and a self-propelled mobile apparatus.

### (ii) Related Art

Japanese Unexamined Patent Application Publication No. 2002-254372, for example, discloses an article delivery system. In the article delivery system, authentication is performed on the basis of authentication information input by a visitor. If it is determined that the authentication has been successfully completed, communication with an owner is performed, and then authentication is performed again. If it is determined that the authentication has been successfully completed, the owner is notified of the visitor, and the input information regarding the visitor is transmitted to the owner. If the owner gives an instruction to receive an article, a door is unlocked, and an operation necessary to receive the article is performed. The door is then locked, and information regarding a result of the operation is transmitted to the owner.

### SUMMARY

A self-propelled mobile apparatus is caused to move, for example, in order to transport an object or a person. In this case, a user of the self-propelled mobile apparatus might not be able to use the self-propelled mobile apparatus since the self-propelled mobile apparatus is moving.

Aspects of non-limiting embodiments of the present disclosure relate to increase a possibility that a user of a self-propelled mobile apparatus can use the self-propelled mobile apparatus any time the user desires, compared to when the self-propelled mobile apparatus moves regardless of scheduled times and places at which the user will use the self-propelled mobile apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including an obtaining unit that obtains settings of a scheduled time and a scheduled place at which a first user is to use the self-propelled mobile apparatus, the scheduled time and the scheduled place being set by the first user, a reception unit that receives at least one instruction of a movement for the self-propelled mobile apparatus, the at least one instruction being given by a second user, and a control unit that, if execution of the instructed movement would prevent the scheduled use of the self-propelled mobile apparatus from taking place at the scheduled place from the scheduled time, causes the self-propelled mobile apparatus not to execute the instructed movement.

### BRIEF DESCRIPTION OF THE DRAWINGS

An exemplary embodiment of the present disclosure will be described in detail based on the following figures, wherein:

FIG. 1 is a diagram illustrating an example of the overall configuration of a transportation system according to an exemplary embodiment;

FIG. 2 is a diagram illustrating an example of the hardware configuration of a self-propelled mobile apparatus according to the exemplary embodiment;

FIG. 3 is a diagram illustrating an example of the hardware configuration of a transportation management server according to the exemplary embodiment;

FIG. 4 is a block diagram illustrating an example of the functional configuration of the self-propelled mobile apparatus according to the exemplary embodiment;

FIG. 5 is a diagram illustrating an example of a screen for receiving owner use conditions;

FIG. 6 is a diagram illustrating an example of a screen for a list of transportation requests transmitted from the transportation management server;

FIG. 7 is a diagram illustrating an example of a determination made by a transportation possibility determination unit of the self-propelled mobile apparatus;

FIGS. 8A and 8B are flowcharts illustrating an example of a process performed when an owner selects a transportation request;

FIGS. 9A and 9B are flowcharts illustrating an example of a process performed when a transportation company specifies a transportation request; and

FIGS. 10A and 10B are flowcharts illustrating an example of a process performed when the owner cancels transportation performed by the self-propelled mobile apparatus.

### DETAILED DESCRIPTION

An exemplary embodiment of the present disclosure will be described in detail hereinafter with reference to the accompanying drawings.

### Overall Configuration of System

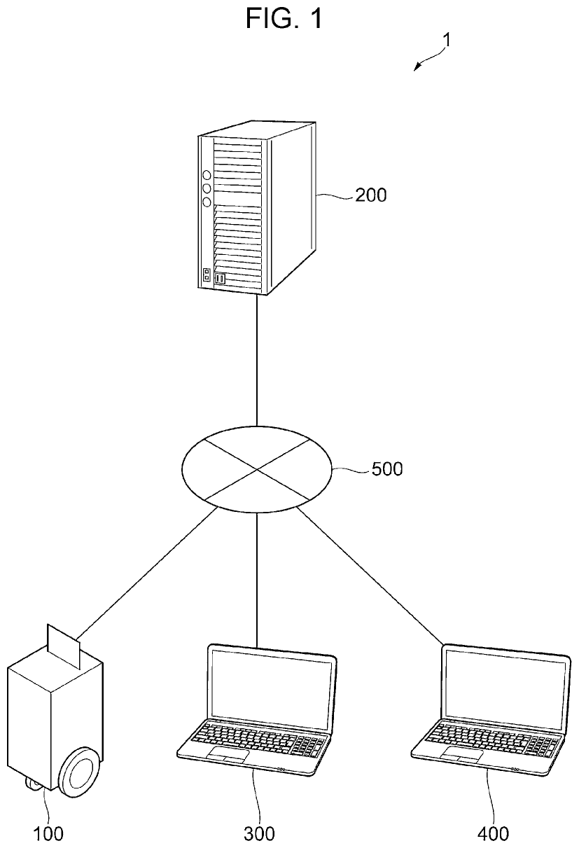

FIG. 1 is a diagram illustrating an example of the overall configuration of a transportation system 1 according to the present exemplary embodiment. As illustrated in FIG. 1, the transportation system 1 according to the present exemplary embodiment includes a self-propelled mobile apparatus 100, a transportation management server 200, an owner terminal 300, and a client terminal 400. The self-propelled mobile apparatus 100, the transportation management server 200, the owner terminal 300, and the client terminal 400 are connected to a network 500.

The self-propelled mobile apparatus 100 transports an object or a person within a predetermined range such as a local community. Here, an owner of the self-propelled mobile apparatus 100 has a right to use the self-propelled mobile apparatus 100 preferentially. The self-propelled mobile apparatus 100 provides various functions for the owner, for example, at the owner's home or another place where the owner has gone. When the owner is not using the self-propelled mobile apparatus 100, the self-propelled mobile apparatus 100 transports an object or a person at the request of another person.

In the following description, the self-propelled mobile apparatus 100 transports a load, which may be an object or a person.

In the following description, the owner of the self-propelled mobile apparatus 100 might be simply referred to as an “owner”. In the present exemplary embodiment, the owner is an example of a first user.

The transportation management server 200 is a computer that manages transportation of loads. The transportation management server 200 may be, for example, a server apparatus, a personal computer (PC), or the like. A transportation company or the like that provides a service for transporting loads, for example, manages the transportation management server 200. The transportation management server 200 receives a request to transport a load from the client terminal 400 owned by a client who desires to transport the load and transmits the request to transport a load to the self-propelled mobile apparatus 100.

The owner terminal 300 is a computer operated by the owner of the self-propelled mobile apparatus 100. The owner terminal 300 may be, for example, a mobile information terminal such as a PC, a smartphone, or a mobile phone. The owner terminal 300 receives use conditions (hereinafter referred to as “owner use conditions”) under which the owner uses the self-propelled mobile apparatus 100 and transmits the owner use conditions to the self-propelled mobile apparatus 100. The owner use conditions are set by the owner for himself/herself, and include information such as a use time, use duration, and a use place relating to use of the self-propelled mobile apparatus 100 by the owner.

The client terminal 400 is a computer operated by the client who desires to transport a load. The client terminal 400 may be, for example, a mobile information terminal such as a PC, a smartphone, or a mobile phone. The client terminal 400 receives a request to transport a load from the client who desires to transport the load and transmits the request to the transportation management server 200. The request includes information such as an address from which the load is to be transported, an address to which the load is to be transported, a time point at which the load is to be transported, and a type of load.

The network 500 is a communication medium used for information communication performed by the self-propelled mobile apparatus 100, the transportation management server 200, the owner terminal 300, and the client terminal 400. The network 500 may be, for example, the Internet, a public telephone circuit, or a local area network (LAN). The network 500 may employ wired communication or wireless communication.

Although FIG. 1 illustrates only one self-propelled mobile apparatus 100, the number of self-propelled mobile apparatuses 100 used is not limited to one. In other words, the transportation of loads managed by the transportation management server 200 is achieved by one or a plurality of self-propelled mobile apparatuses 100.

Although FIG. 1 illustrates only one client terminal 400, the number of client terminals 400 is not limited to one. In other words, one or a plurality of clients operate client terminals 400 to issue requests to transport loads.

### Hardware Configuration of Self-Propelled Mobile Apparatus

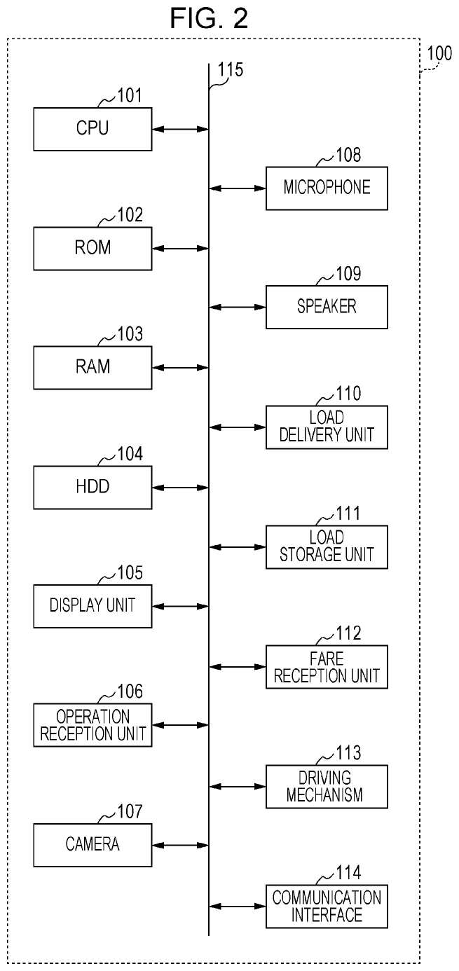

FIG. 2 is a diagram illustrating an example of the hardware configuration of the self-propelled mobile apparatus 100 according to the present exemplary embodiment.

As illustrated in FIG. 2, the self-propelled mobile apparatus 100 according to the present exemplary embodiment includes a central processing unit (CPU) 101 that controls the entirety of the self-propelled mobile apparatus 100 by executing programs (include firmware), a read-only memory (ROM) 102 storing programs such as basic input/output system (BIOS) and firmware, and a random-access memory (RAM) 103 used as an execution area for the programs.

The self-propelled mobile apparatus 100 includes a hard disk drive (HDD) 104, which is a storage area storing various programs such as an operating system (OS) and applications, data input to the various programs, and data output from the various programs.

In the present exemplary embodiment, the configuration including the CPU 101, the ROM 102, the RAM 103, and the HDD 104 function as an example of an information processing system.

The self-propelled mobile apparatus 100 also includes a display unit 105 that displays a user interface screen and the like, an operation reception unit 106 that receives user operations with a touch panel or the like, a camera 107 that captures images of scenes around the self-propelled mobile apparatus 100, a microphone 108 that detects external sound, and a speaker 109 that outputs sound.

The self-propelled mobile apparatus 100 also includes a load delivery unit 110 for receiving a load from a user and delivering a load to a user, and a load storage unit 111 that stores a load received from a user, and a fare reception unit 112 for receiving cash from a user and giving change to a user.

The self-propelled mobile apparatus 100 also includes a driving mechanism 113 that achieves autonomous driving by driving wheels (not illustrated). The driving mechanism 113 according to the present exemplary embodiment is an example of a movement unit and includes a motor for driving the wheels and a steering mechanism that controls an angle of the wheels. The self-propelled mobile apparatus 100 moves forward or backward as the wheels rotate. A moving direction of the self-propelled mobile apparatus 100 changes in accordance with the angle of the wheels.

The self-propelled mobile apparatus 100 also includes a communication interface 114 used for communication with the outside.

The above components are connected to one another through a bus 115 and communicate data with one another through the bus 115.

### Hardware Configuration of Transportation Management Server

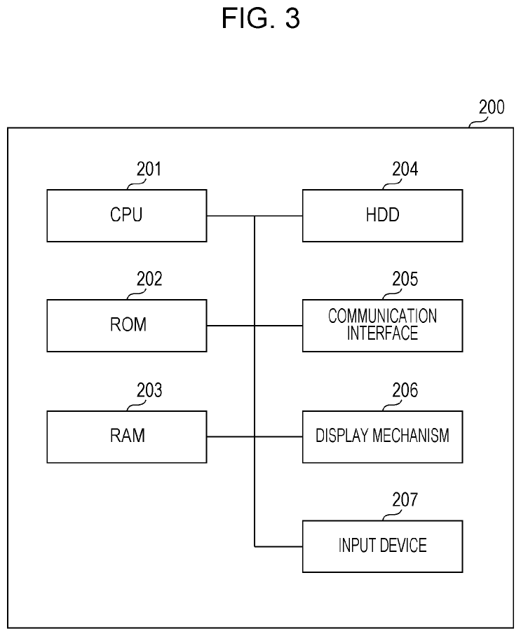

FIG. 3 is a diagram illustrating an example of the hardware configuration of the transportation management server 200 according to the present exemplary embodiment.

As illustrated in FIG. 3, the transportation management server 200 according to the present exemplary embodiment includes a CPU 201, which is an arithmetic unit, a ROM 202, which is a storage area storing programs such as BIOS, and a RAM 203, which is an execution area for the programs. The transportation management server 200 also includes an HDD 204, which is a storage area storing various programs such as an OS and applications, data input to the various programs, and data output from the various programs. The CPU 201 loads the various programs stored in the output circuit 204 and executes the programs, for example, to achieve various functions of the transportation management server 200.

The transportation management server 200 also includes a communication interface 205 for communicating with the outside, a display mechanism 206 such as a display, and an input device 207 such as keyboard, a mouse, or a touch panel.

The hardware configuration of the owner terminal 300 and the client terminal 400 may be the same, for example, as that of the transportation management server 200 illustrated in FIG. 3.

### Functional Configuration of Self-Propelled Mobile Apparatus

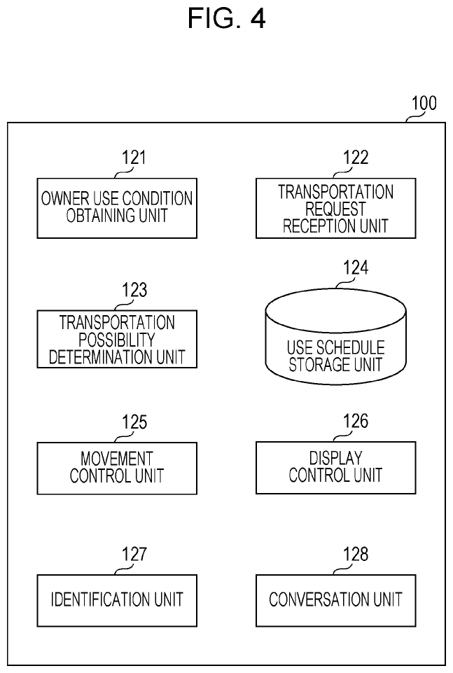

Next, the functional configuration of the self-propelled mobile apparatus 100 according to the present exemplary embodiment will be described. FIG. 4 is a block diagram illustrating an example of the functional configuration of the self-propelled mobile apparatus 100 according to the present exemplary embodiment. The self-propelled mobile apparatus 100 according to the present exemplary embodiment includes an owner use condition obtaining unit 121, a transportation request reception unit 122, a transportation possibility determination unit 123, a use schedule storage unit 124, a movement control unit 125, a display control unit 126, an identification unit 127, and a conversation unit 128.

The owner use condition obtaining unit 121 obtains owner use conditions from the owner terminal 300. The owner use condition obtaining unit 121 registers the obtained owner use conditions in a use schedule of the self-propelled mobile apparatus 100 stored in the use schedule storage unit 124. As described later, the owner use conditions are used to determine whether to perform transportation requested by a client other than the owner.

The owner use conditions include information such as a use time, use duration, and a use place relating to use of the self-propelled mobile apparatus 100 by the owner. More specifically, the owner use conditions include a scheduled time at which the owner will start using the self-propelled mobile apparatus 100 (hereinafter referred to as a “scheduled start time”) and a scheduled time at which the owner will stop using the self-propelled mobile apparatus 100 (hereinafter referred to as a “scheduled end time”). The owner use conditions also include a scheduled place at which the owner will start using the self-propelled mobile apparatus 100 (hereinafter referred to as a “scheduled start place”) and a scheduled place at which the owner will stop using the self-propelled mobile apparatus 100 (hereinafter referred to as a “scheduled end place”).

The scheduled start place is a place where the owner will start using the self-propelled mobile apparatus 100 at the scheduled start time. The scheduled end place is a place where the owner will stop using the self-propelled mobile apparatus 100 at the scheduled end time.

The transportation request reception unit 122 receives a request to transport a load from the transportation management server 200 with the owner use conditions set. The request to transport a load has been received by the client terminal 400 from the client. That is, the request to transport a load is a transportation instruction given by a client other than the owner and an instruction to move the self-propelled mobile apparatus 100. In the present exemplary embodiment, the client other than the owner is an example of a second user.

When the transportation request reception unit 122 receives a transportation request, the owner may select the transportation request from a list of transportation requests transmitted from the transportation management server 200 or the transportation company may specify the transportation request. Details of these cases will be described later.

The transportation possibility determination unit 123 determines, on the basis of the use schedule stored in the use schedule storage unit 124 and a transportation request received by the transportation request reception unit 122, whether transportation based on the transportation request is possible. At this time, the transportation possibility determination unit 123 determines, on the basis of the use schedule stored in the use schedule storage unit 124, whether execution of the transportation based on the transportation request would prevent scheduled use of the self-propelled mobile apparatus 100 from taking place at a scheduled start place from a scheduled start time.

If the execution of the transportation based on the transportation request would prevent scheduled use of the self-propelled mobile apparatus 100 from taking place at a scheduled start place from a scheduled start time, the transportation possibility determination unit 123 determines that the transportation is not possible. That is, the transportation possibility determination unit 123 does not permit execution of movement according to an instruction that would prevent scheduled use of the self-propelled mobile apparatus 100 from taking place at a scheduled start place from a scheduled start time. If the execution of the transportation based on the transportation request would not prevent scheduled use of the self-propelled mobile apparatus 100 from taking place at a scheduled start place from a scheduled start time, on the other hand, the transportation possibility determination unit 123 determines that the transportation is possible. The transportation possibility determination unit 123 then registers the transportation request in the use schedule of the self-propelled mobile apparatus 100 stored in the use schedule storage unit 124.

The use schedule storage unit 124 stores the use schedule, which is a schedule according to which the self-propelled mobile apparatus 100 will be used. The use schedule includes owner use conditions and transportation requests for which the transportation possibility determination unit 123 has determined that transportation is possible.

The movement control unit 125 controls the driving mechanism 113 (refer to FIG. 1) to control movement of the self-propelled mobile apparatus 100. The movement control unit 125 controls, for example, forward movement, backward movement, stopping, and a moving direction. The movement control unit 125 controls the movement of the self-propelled mobile apparatus 100 on the basis of the use schedule stored in the use schedule storage unit 124.

More specifically, the movement control unit 125 controls the movement of the self-propelled mobile apparatus 100 on the basis of the use schedule stored in the use schedule storage unit 124 such that the self-propelled mobile apparatus 100 will arrive at a place from which a load will be transported at a time specified by a transportation request. After the self-propelled mobile apparatus 100 arrives at the place, the load delivery unit 110 receives the load. After the load is received, the movement control unit 125 controls the movement of the self-propelled mobile apparatus 100 such that the self-propelled mobile apparatus 100 will arrive at a place to which the load will be transported at a time specified by the transportation request. After the self-propelled mobile apparatus 100 arrives at the place, the load delivery unit 110 delivers the load. After the delivery of the load is completed, the self-propelled mobile apparatus 100 notifies the transportation management server 200, the owner terminal 300, and the client terminal 400 of the completion of the transportation. The movement control unit 125 then controls the movement of the self-propelled mobile apparatus 100 such that the self-propelled mobile apparatus 100 will arrive at a scheduled start place by a scheduled start time.

The display control unit 126 outputs data for displaying a screen on the display unit 105 to control the display unit 105.

The identification unit 127 has a function of recognizing speech sound and a function of recognizing persons' faces. For example, the identification unit 127 identifies a person who is uttering a speech sound by recognizing the speech sound collected by the microphone 108 or comparing the speech sound with speech sounds registered in advance. Alternatively, for example, the identification unit 127 identifies a person around the self-propelled mobile apparatus 100 by comparing an image of the person captured by the camera 107 with photographs of persons registered in advance.

The conversation unit 128 has conversations with the owner, clients, and other persons. For example, the conversation unit 128 stores predetermined conversation rules and outputs a speech sound from the speaker 109 in accordance with words uttered by the owner. After the self-propelled mobile apparatus 100 arrives at a place from which a load will be transported, for example, the conversation unit 128 outputs sounds indicating the arrival and reception of the load through the speaker 109.

The functional units of the self-propelled mobile apparatus 100 are achieved by a combination of software resources and hardware resources. More specifically, when the self-propelled mobile apparatus 100 is achieved by the hardware configuration illustrated in FIG. 2, for example, the various programs stored in the HDD 104 or the like are loaded into the RAM 103 and executed by the CPU 101. As a result, the owner use condition obtaining unit 121, the transportation request reception unit 122, the transportation possibility determination unit 123, the movement control unit 125, the display control unit 126, the identification unit 127, and the conversation unit 128 are achieved. The use schedule storage unit 124 is achieved, for example, by the HDD 104 or the like.

In the present exemplary embodiment, the owner use condition obtaining unit 121 is used as an example of an obtaining unit. The transportation request reception unit 122 is used as an example of a reception unit. The transportation possibility determination unit 123 and the movement control unit 125 are used as an example of a control unit. The display control unit 126 is used as an example of a display unit.

### Functions Provided by Self-Propelled Mobile Apparatus for Owner

When the self-propelled mobile apparatus 100 is not transporting a load, the self-propelled mobile apparatus 100 provides various functions for the owner, for example, at the owner's home or another place where the owner has gone. More specifically, the self-propelled mobile apparatus 100 provides a self-driving function, a transportation function, a conversation function, and a charging function, for example, for the owner.

For example, the self-propelled mobile apparatus 100 uses the self-driving function to operate as an autonomous vehicle for moving within a predetermined range such as a local community. In the self-driving function, if the owner gets on the self-propelled mobile apparatus 100 and specifies a destination, the self-propelled mobile apparatus 100 autonomously moves to the destination. Upon arriving at the destination, the self-propelled mobile apparatus 100 notifies, through a sound, a mail, or the like, a person at the destination of the arrival of the owner.

In addition, for example, the self-propelled mobile apparatus 100 uses the transportation function to transport a load for the owner or receive a load transported by another self-propelled mobile apparatus 100. If the owner approves, for example, the self-propelled mobile apparatus 100 receives a load delivered to the owner's home and reports the reception of the load to the owner.

In addition, for example, the self-propelled mobile apparatus 100 uses the conversation function to have a conversation with the owner. In addition, for example, the self-propelled mobile apparatus 100 uses the charging function to autonomously move to a charger and starts to charge.

A waiting place is predetermined for the self-propelled mobile apparatus 100. In a time period that is not specified by the owner use conditions or a time period in which the self-propelled mobile apparatus 100 is not transporting a load, the self-propelled mobile apparatus 100 waits at the predetermined waiting place. The waiting place is, for example, the owner's home.

### When Owner Selects Transportation Request

Next, a case where the owner selects a transportation request from a list of transportation requests transmitted from the transportation management server 200 will be described as an example of a case where the transportation request reception unit 122 of the self-propelled mobile apparatus 100 receives a transportation request.

The self-propelled mobile apparatus 100 or the owner terminal 300 obtains a list of transportation requests from the transportation management server 200. The list of transportation requests is a list of transportation requests received by one or a plurality of client terminals 400. The owner may select, from the list, a transportation request to be received by the self-propelled mobile apparatus 100.

If the owner selects a transportation request from the list, the transportation request reception unit 122 receives the transportation request selected by the owner. The transportation possibility determination unit 123 then determines, on the basis of the use schedule stored in the use schedule storage unit 124 and the transportation request selected by the owner, whether transportation based on the transportation request is possible. If determining that the transportation is not possible, for example, the transportation possibility determination unit 123 notifies the owner that the transportation is not possible. If determining that the transportation is possible, on the other hand, the transportation possibility determination unit 123 notifies the owner that the transportation is possible, and transmits the transportation request selected by the owner to the transportation management server 200.

Next, the transportation management server 200 determines whether to actually cause the self-propelled mobile apparatus 100 to perform the transportation based on the transportation request selected by the owner. At this time, an operator (i.e., the transportation company) of the transportation management server 200 determines whether to actually cause the self-propelled mobile apparatus 100 to perform the transportation based on the transportation request selected by the owner. If the transportation management server 200 determines that the self-propelled mobile apparatus 100 is actually caused to perform the transportation based on the transportation request selected by the owner, the transportation request reception unit 122 of the self-propelled mobile apparatus 100 officially accepts the transportation request selected by the owner from the transportation management server 200.

Although the transportation possibility determination unit 123 makes a determination immediately after the owner selects a transportation request from the list of transportation requests, the transportation request selected by the owner may be transmitted to the transportation management server 200 before the transportation possibility determination unit 123 makes a determination, instead. In this case, the transportation possibility determination unit 123 makes a determination after the transportation management server 200 determines that the self-propelled mobile apparatus 100 is actually caused to perform the transportation based on the transportation request selected by the owner.

If the owner selects a transportation request from the list of transportation requests and the transportation possibility determination unit 123 determines that transportation is possible, the self-propelled mobile apparatus 100 may officially perform the transportation based on the transportation request, instead, even if the transportation management server 200 has not determined whether to actually cause the self-propelled mobile apparatus 100 to perform the transportation based on the transportation request.

### When Transportation Company Specifies Transportation Request

Next, a case where the transportation company specifies a transportation request will be described as another example of the case where the transportation request reception unit 122 of the self-propelled mobile apparatus 100 receives a transportation request.

First, the self-propelled mobile apparatus 100 or the owner terminal 300 transmits owner use conditions to the transportation management server 200. Next, the operator (i.e., the transportation company) of the transportation management server 200 checks time periods in which the owner will not use the self-propelled mobile apparatus 100. If there are a plurality of self-propelled mobile apparatuses 100 in the transportation system 1, the operator of the transportation management server 200 checks time periods in which owners of the self-propelled mobile apparatuses 100 will not use their respective self-propelled mobile apparatuses 100. The operator of the transportation management server 200 then specifies a transportation request to be transmitted to the self-propelled mobile apparatus 100. The transportation request reception unit 122 of the self-propelled mobile apparatus 100 receives the specified transportation request from the transportation management server 200. The transportation possibility determination unit 123 then makes a determination.

Here, however, the self-propelled mobile apparatus 100 may receive a transportation request from the transportation management server 200 without owner use conditions being transmitted to the transportation management server 200, instead. In this case, too, the transportation request reception unit 122 receives the transportation request, and the transportation possibility determination unit 123 makes a determination.

If the transportation request reception unit 122 receives a transportation request specified by the transportation company and the transportation possibility determination unit 123 determines that transportation is possible, the owner may be asked to approve the transportation request.

When the owner is asked to approve a transportation request, for example, a screen for enabling the owner to determine whether to perform transportation is displayed on the display unit 105 or a display of the owner terminal 300. If the owner approves the transportation request, the transportation possibility determination unit 123 registers the approved transportation request in the use schedule of the self-propelled mobile apparatus 100 stored in the use schedule storage unit 124. If the owner rejects the transportation request, on the other hand, the transportation possibility determination unit 123 notifies the transportation management server 200 of the rejection of the transportation request.

If the owner does not approve a transportation request within a certain period of time after the owner is asked to approve the transportation request, the self-propelled mobile apparatus 100 may operate in accordance with an operation setting at a time when the owner has not approved a transportation request.

One of the following three settings is used, for example, as the operation setting at a time when the owner has not approved a transportation request.

A first setting is a setting for rejecting a transportation request. In this setting, if the owner does not approve a transportation request within a certain period of time, the transportation possibility determination unit 123 determines that transportation is not possible. The transportation possibility determination unit 123 then notifies the transportation management server 200 of the reception of the transportation request.

A second setting is a setting for making a determination from the owner's use history of the self-propelled mobile apparatus 100. In this setting, if the owner does not approve a transportation request within the certain period of time, the transportation possibility determination unit 123 determines, on the basis of the owner's use history of the self-propelled mobile apparatus 100, whether transportation based on the transportation request is possible. The self-propelled mobile apparatus 100 accumulates records of use of the self-propelled mobile apparatus 100 by the owner, for example, as a database for the owner's use history.

If the owner's use history indicates that a use ratio of the self-propelled mobile apparatus 100 by the owner at times related to a time specified by a transportation request is equal to or higher than a predetermined value, for example, the transportation possibility determination unit 123 determines that the transportation is not possible. If the owner's use history indicates that the use ratio of the self-propelled mobile apparatus 100 by the owner at the times related to the specified time is lower than the predetermined value, the transportation possibility determination unit 123 determines that the transportation is possible.

Times related to a time specified by a transportation request are, for example, time periods that are the same as the specified time of transportation on dates (e.g., for a month or a year) before the specified time of transportation based on the transportation request. Alternatively, times related to a time specified by a transportation request are, for example, days and time periods that are the same as the specified time of transportation based on the transportation request on dates before the specified time of the transportation based on the transportation request.

A third setting is a setting for making a determination from positional information indicating a position of the owner. In this setting, the transportation possibility determination unit 123 determines, on the basis of the positional information regarding the owner, whether transportation based on a transportation request is possible. In this setting, the position of the owner when the owner uses the self-propelled mobile apparatus 100 is also set in advance.

A case where the owner's home is set as the position of the owner at a time when the owner uses the self-propelled mobile apparatus 100, for example, will be described. If it is determined from the positional information regarding the owner that the owner is home, for example, the transportation possibility determination unit 123 determines that transportation is not possible, because the owner is using the self-propelled mobile apparatus 100 at home. If it is determined from the positional information regarding the owner that the owner is not home, on the other hand, the transportation possibility determination unit 123 determines that transportation is possible.

If the owner is not home but is going home, for example, the transportation possibility determination unit 123 may determine that transportation is not possible.

If it is determined that the self-propelled mobile apparatus 100 can complete transportation based on a transportation request and arrive at the owner's home before the owner arrives at his/her home, for example, the transportation possibility determination unit 123 may determine that the transportation is possible. If it is determined that it is difficult for the self-propelled mobile apparatus 100 to complete transportation based on a transportation request and arrive at the owner's home before the owner arrives at his/her home, on the other hand, the transportation possibility determination unit 123 may determine that the transportation is not possible.

A case where a place other than the owner's home is set as the position of the owner at a time when the owner uses the self-propelled mobile apparatus 100, for example, will be described. If it is determined from the positional information regarding the owner that the owner is home, for example, the transportation possibility determination unit 123 may determine that transportation is possible. If it is determined from the positional information regarding the owner that the owner is not home, on the other hand, the transportation possibility determination unit 123 determines that transportation is not possible, because the self-propelled mobile apparatus 100 performs operations at the owner's home.

If the owner is home but scheduled to go outside and it is difficult for the self-propelled mobile apparatus 100 to complete transportation based on a transportation request and arrive at the owner's home before the owner leaves his/her home, for example, the transportation possibility determination unit 123 may determine that the transportation is not possible. If the self-propelled mobile apparatus 100 can complete transportation based on a transportation request and arrive at the owner's home before the owner leaves his/her home, on the other hand, the transportation possibility determination unit 123 may determine that the transportation is possible.

In the third setting, not only the positional information regarding the owner but also positional information regarding another person may be used. The other person may be, for example, one of the owner's family members, a person who lives with the owner, or the like. A case where the owner's home is set as the position of the owner at a time when the owner uses the self-propelled mobile apparatus 100, for example, will be described as a specific example. In this case, if the owner or at least one of the owner's family members is home, for example, the transportation possibility determination unit 123 determines that transportation is not possible. If the owner and the rest of the owner's family members are not home, on the other hand, the transportation possibility determination unit 123 determines that transportation is possible. If the owner and the rest of the owner's family members are not home but at least one of them is going home, for example, the transportation possibility determination unit 123 determines that transportation is not possible.

Although the owner is asked to approve a transportation request in the above description when the transportation company specifies the transportation request and the self-propelled mobile apparatus 100 directly communicates with the transportation management server 200, the owner may be asked to approve a transportation request even when the self-propelled mobile apparatus 100 does not directly communicate with the transportation management server 200, instead. For example, the owner may be asked to approve a transportation request when the owner selects the transportation request.

### When Transportation is Canceled

Next, a case where the owner cancels transportation performed by the self-propelled mobile apparatus 100 will be described. The owner may cancel transportation based on a transportation request for which the transportation possibility determination unit 123 has determined that transportation is possible. In this case, the owner uses the owner terminal 300 to instruct the self-propelled mobile apparatus 100 to cancel transportation.

More specifically, if a load to be transported has not been loaded onto the self-propelled mobile apparatus 100 when the owner has canceled transportation based on a transportation request, the self-propelled mobile apparatus 100 confirms the cancellation. That is, the self-propelled mobile apparatus 100 cancels the transportation based on the transportation request. If a load to be transported has been loaded onto the self-propelled mobile apparatus 100 when the owner has canceled transportation based on a transportation request, on the other hand, the self-propelled mobile apparatus 100 rejects the cancellation. Since the load has already been loaded onto the self-propelled mobile apparatus 100, the self-propelled mobile apparatus 100 completes the transportation of the load.

If transportation of a load is executable by another self-propelled mobile apparatus, however, cancellation may be confirmed even after the load has been loaded onto the self-propelled mobile apparatus 100. If the self-propelled mobile apparatus 100 receives an instruction to cancel transportation of a load based on a transportation request, for example, the self-propelled mobile apparatus 100 inquires the transportation management server 200 whether the transportation is executable by another self-propelled mobile apparatus. The transportation management server 200 determines whether the transportation is executable by another self-propelled mobile apparatus.

If determining that the transportation is executable by another self-propelled mobile apparatus, the transportation management server 200 instructs the self-propelled mobile apparatus 100 to confirm the cancellation. The transportation management server 200 also notifies the self-propelled mobile apparatus 100 of information regarding the other self-propelled mobile apparatus 100. The transportation management server 200 then allows the self-propelled mobile apparatus 100 to communicate with the other self-propelled mobile apparatus 100. The self-propelled mobile apparatus 100 communicates with the other self-propelled mobile apparatus 100 to determine a place for taking over the transportation. The self-propelled mobile apparatus 100 then moves to the place for taking over the transportation and delivers the load to the other self-propelled mobile apparatus 100.

If determining that the transportation is not executable by another self-propelled mobile apparatus, on the other hand, the transportation management server 200 instructs the self-propelled mobile apparatus 100 not to confirm the cancellation. In this case, the self-propelled mobile apparatus 100 completes the transportation.

The other self-propelled mobile apparatus 100 that can execute the transportation is, for example, another self-propelled mobile apparatus 100 that is located within a predetermined range from a current position of the self-propelled mobile apparatus 100 and that is not transporting a load. The transportation management server 200 determines, on the basis of the current position of the self-propelled mobile apparatus 100, current positions of other self-propelled mobile apparatuses 100, and the progress of transportation based on transportation requests, whether the transportation is executable by another self-propelled mobile apparatus. The self-propelled mobile apparatus 100, not the transportation management server 200, may make the determination whether the transportation is executable by another self-propelled mobile apparatus, instead.

Although the self-propelled mobile apparatus 100 communicates with the other self-propelled mobile apparatus 100 to determine a place for taking over transportation of a load in the above example, the transportation management server 200 may determine the place, instead. In this case, the transportation management server 200 notifies the self-propelled mobile apparatus 100 and the other self-propelled mobile apparatus 100 of the place for taking over the transportation.

### Screens Displayed on Owner Terminal

Next, screens displayed on the owner terminal 300 will be described later. The owner terminal 300 displays, for example, a screen for receiving owner use conditions and a screen for a list of transportation requests transmitted from the transportation management server 200. These screens, however, may be displayed on the display unit 105 of the self-propelled mobile apparatus 100, instead.

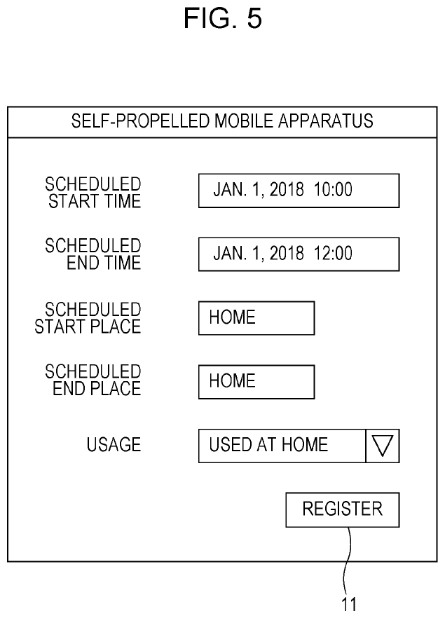

FIG. 5 is a diagram illustrating an example of the screen for receiving owner use conditions. In FIG. 5, a scheduled start time is 10:00 on Jan. 1, 2018, and a scheduled end time is 12:00 on Jan. 1, 2018. A scheduled start place and a scheduled end place are the owner's home, and usage is “used at home”. A pull-down menu is used for the usage, and options include, for example, “used at home”, “transport load”, and “move to destination”. If the owner selects a “register” button 11, the input owner use conditions are registered in the use schedule of the self-propelled mobile apparatus 100.

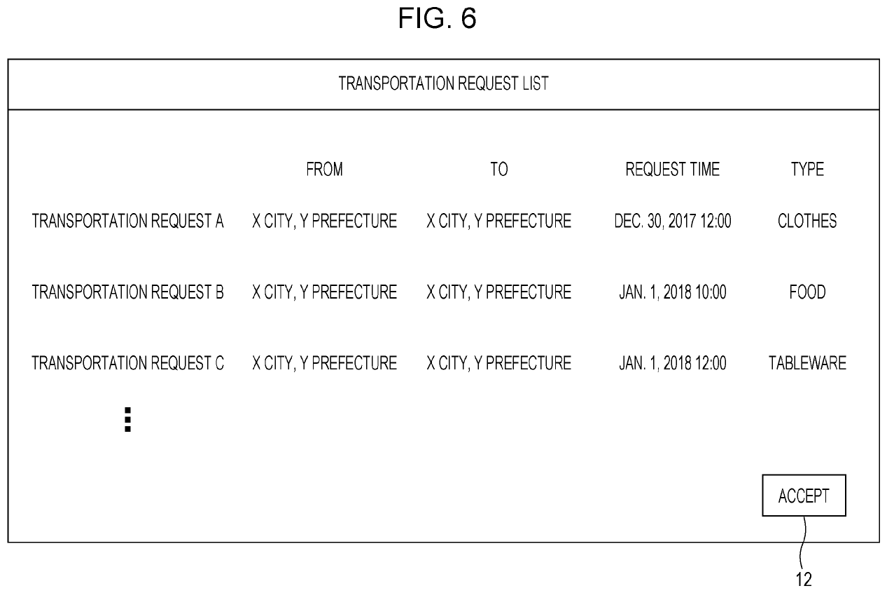

Next, FIG. 6 is a diagram illustrating an example of the screen of a list of transportation requests transmitted from the transportation management server 200. In FIG. 6, “from” indicates an address of a place from which a load is to be transported, “to” indicates an address of a place to which a load is to be transported, “request time” indicates a time at which a load is to be transported (i.e., a time at which the self-propelled mobile apparatus 100 receives a load at a place from which the load is to be transported), and “type” indicates a type of load. These pieces of information are displayed for each transportation request. If the owner selects one of transportation requests and selects an “accept” button 12, the transportation possibility determination unit 123 of the self-propelled mobile apparatus 100 determines whether transportation based on the transportation request selected by the owner is possible. A result of the determination is then displayed.

The owner terminal 300 or the self-propelled mobile apparatus 100 may display information regarding whether transportation based on a transportation request is possible.

If the owner selects one of the transportation requests on the screen illustrated in FIG. 6, for example, time periods in which transportation based on the transportation request is possible may be displayed in addition to, or instead of, whether the transportation is possible. In this case, the transportation possibility determination unit 123 identifies time periods in which the transportation is possible on the basis of the use schedule stored in the use schedule storage unit 124 and the transportation request selected by the owner. More specifically, the transportation possibility determination unit 123 identifies, from time periods in the use schedule of the self-propelled mobile apparatus 100 in which use by the owner or transportation has not been registered, time periods that would not prevent scheduled use of the self-propelled mobile apparatus 100 from taking place at a scheduled start place from a scheduled start time. In addition, the transportation possibility determination unit 123 identifies time periods that would not prevent transportation that has been registered earlier.

Alternatively, for example, whether transportation based on each transportation request is possible may be displayed on the screen illustrated in FIG. 6, regardless of whether the owner will select the transportation request. In this case, the transportation possibility determination unit 123 determines, on the basis of the use schedule stored in the use schedule storage unit 124 and each transportation request, whether transportation based on the transportation request is possible. More specifically, for example, whether transportation based on transportation requests A to C is possible is displayed on the screen illustrated in FIG. 6. In this case, for example, transportation requests corresponding to transportation that is possible and transportation requests corresponding to transportation that is not possible are differentiated from each other by displaying the transportation requests corresponding to transportation that is possible in red or in bold. The owner may then select, for example, one of the transportation requests corresponding to transportation that is possible.

### Determination Made by Transportation Possibility Determination Unit

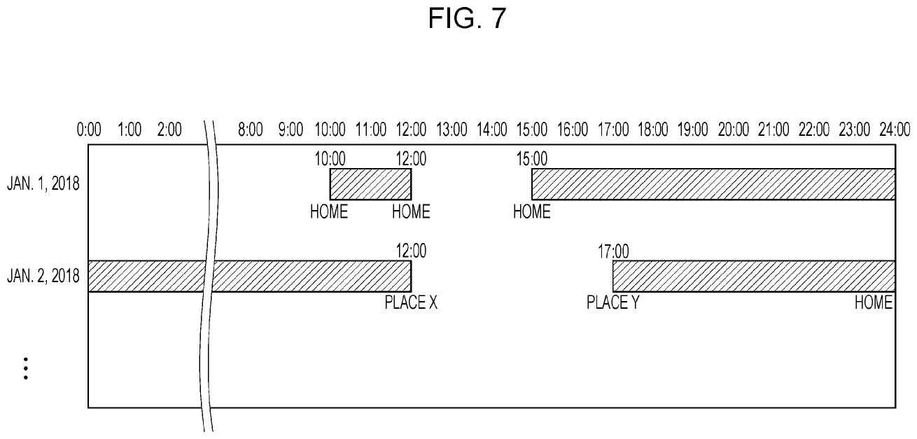

Next, the determination made by the transportation possibility determination unit 123 of the self-propelled mobile apparatus 100 will be described with reference to a specific example. FIG. 7 is a diagram illustrating an example of the determination made by the transportation possibility determination unit 123 of the self-propelled mobile apparatus 100.

In FIG. 7, an example of the use schedule of the self-propelled mobile apparatus 100 stored in the use schedule storage unit 124 is illustrated. For example, the owner will use the self-propelled mobile apparatus 100 from 10:00 to 12:00 on Jan. 1, 2018, from 15:00 on Jan. 1, 2018 to 12:00 on Jan. 2, 2018, and from 17:00 to 24:00 on Jan. 2, 2018. A schedule start place and a schedule end place from 10:00 to 12:00 on Jan. 1, 2018 are the owner's home. A schedule start place from 15:00 on Jan. 1, 2018 to 12:00 on Jan. 2, 2018 is the owner's home, and a scheduled end place is a place X. A scheduled start place from 17:00 to 24:00 on Jan. 2, 2018 is a place Y, and a scheduled end place is the owner's home.

A case where the transportation request reception unit 122 has received a transportation request corresponding to transportation at 13:00 on Jan. 1, 2018 from a place A to a place B, for example, will be described.

In this case, the transportation possibility determination unit 123 determines, on the basis of the use schedule illustrated in FIG. 7 and the received transportation request, whether the transportation based on the transportation request is possible. More specifically, the transportation possibility determination unit 123 determines whether execution of the transportation based on the transportation request would prevent scheduled use of the self-propelled mobile apparatus 100 from taking place at a scheduled start place from a scheduled start time.

If it is difficult for the self-propelled mobile apparatus 100 to leave the owner's home, arrive at the place A at 13:00 on Jan. 1, 2018, and return to the owner's home via the place B by 15:00, for example, it means that the self-propelled mobile apparatus 100 does not arrive at a scheduled start place (the owner's home in this example) by a scheduled start time (15:00 in this example). The transportation possibility determination unit 123 therefore determines that the transportation based on the transportation request is not possible since scheduled use of the self-propelled mobile apparatus 100 at a scheduled start place from a scheduled start time would be prevented from taking place.

It might be necessary to change settings of the self-propelled mobile apparatus 100 before the owner starts using the self-propelled mobile apparatus 100. Because it is necessary to spare time (e.g., 10 minutes) for changing the settings in this case, the self-propelled mobile apparatus 100 needs to arrive at a scheduled start place 10 minutes before a scheduled start time. If it is difficult for the self-propelled mobile apparatus 100 to arrive at the scheduled start place 10 minutes before the scheduled start time, therefore, the transportation possibility determination unit 123 may determine that transportation based on a transportation request is not possible, since scheduled use of the self-propelled mobile apparatus 100 corresponding to the scheduled start time and the scheduled start place would be prevented from taking place.

In the example illustrated in FIG. 7, if it is difficult for the self-propelled mobile apparatus 100 to leave the owner's home at 12:00 on Jan. 1, 2018 and arrive at the place A by 13:00 on Jan. 1, 2018, too, the transportation possibility determination unit 123 determines that the transportation based on the transportation request is not possible.

Next, a case where the transportation request reception unit 122 has received a transportation request corresponding to transportation at 13:00 on Jan. 2, 2018 from the place A to the place B, for example, will be described.

In this case, if it is difficult for the self-propelled mobile apparatus 100 to leave the place X, arrive at the place A at 13:00 on Jan. 2, 2018, and then arrive at the place Y via the place B by 17:00, for example, scheduled use of the self-propelled mobile apparatus 100 corresponding to a scheduled start time (17:00 in this example) and a scheduled start place (the place Y in this example) would be prevented from taking place. The transportation possibility determination unit 123 therefore determines that the transportation based on the transportation request is not possible.

If it is difficult for the self-propelled mobile apparatus 100 to leave the place X at 12:00 and arrive at the place A by 13:00 on Jan. 2, 2018, too, the transportation possibility determination unit 123 determines that the transportation based on the transportation request is not possible.

In the example illustrated in FIG. 7, transportation requests from clients other than the owner have not been registered. If such transportation requests have been registered, the transportation possibility determination unit 123 determines that execution of transportation based on transportation requests that would prevent transportation based on already registered transportation requests is not possible.

In the above determination, time taken for the self-propelled mobile apparatus 100 to go to a certain place is calculated from the speed of the self-propelled mobile apparatus 100 and distance. When the self-propelled mobile apparatus 100 returns to the owner's home via the places A and B, for example, the transportation possibility determination unit 123 calculates time taken for the self-propelled mobile apparatus 100 to return to the owner's home via the places A and B on the basis of a distance between the places A and B and a distance between the place B and the owner's home.

If the self-propelled mobile apparatus 100 receives a load or delivers a load, time taken to receive the load or deliver the load needs to be taken into consideration. The time taken to load a load and the time taken to deliver a load may therefore be determined in advance, and the transportation possibility determination unit 123 may add the time taken to load a load or the time taken to deliver a load to time taken for the self-propelled mobile apparatus 100 to go to a certain place. The transportation possibility determination unit 123 may then determine whether execution of transportation based on a transportation request would prevent scheduled use of the self-propelled mobile apparatus 100 from taking place at a scheduled start place from a scheduled start time.

The use schedule of the self-propelled mobile apparatus 100 illustrated in FIG. 7 may be displayed on the owner terminal 300 or the self-propelled mobile apparatus 100. When the owner selects a transportation request from a list of transportation requests, for example, the owner may specify, in the use schedule of the self-propelled mobile apparatus 100 illustrated in FIG. 7, a time at which the self-propelled mobile apparatus 100 is not used. Transportation requests corresponding to transportation that can be performed by the self-propelled mobile apparatus 100 at the specified time may then be displayed.

Processes Performed when Transportation Request is Received

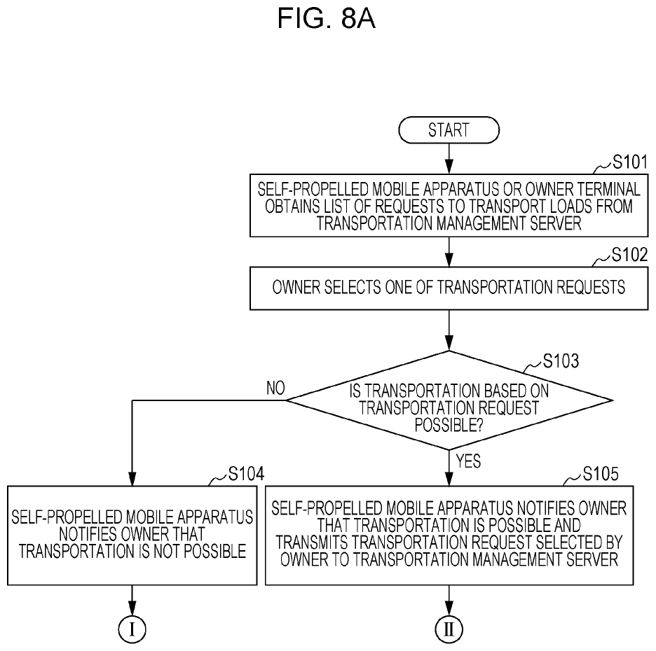

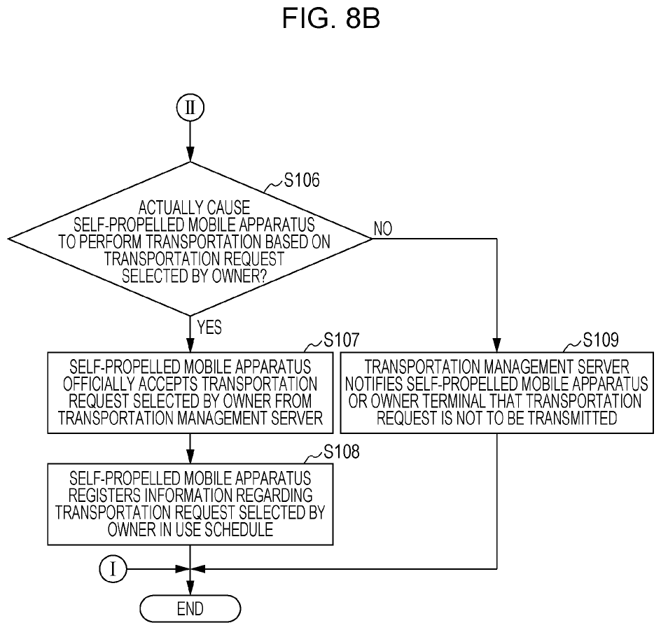

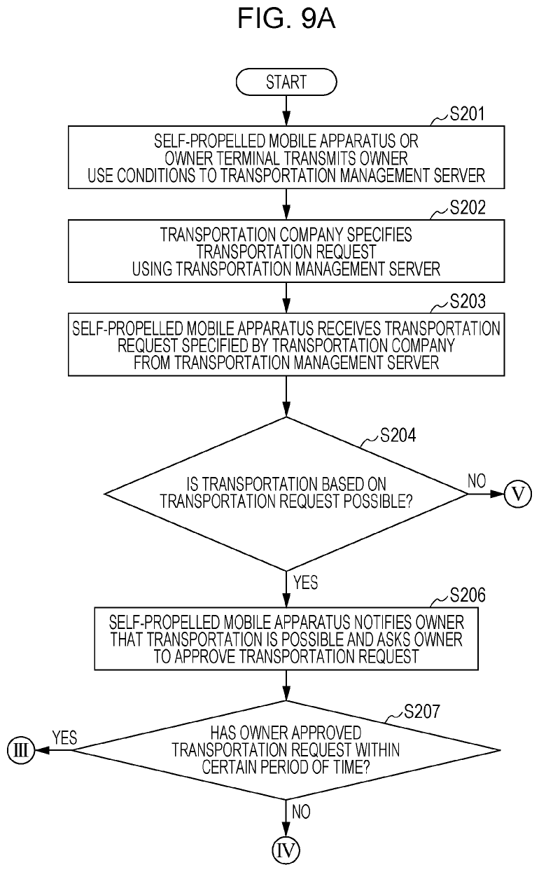

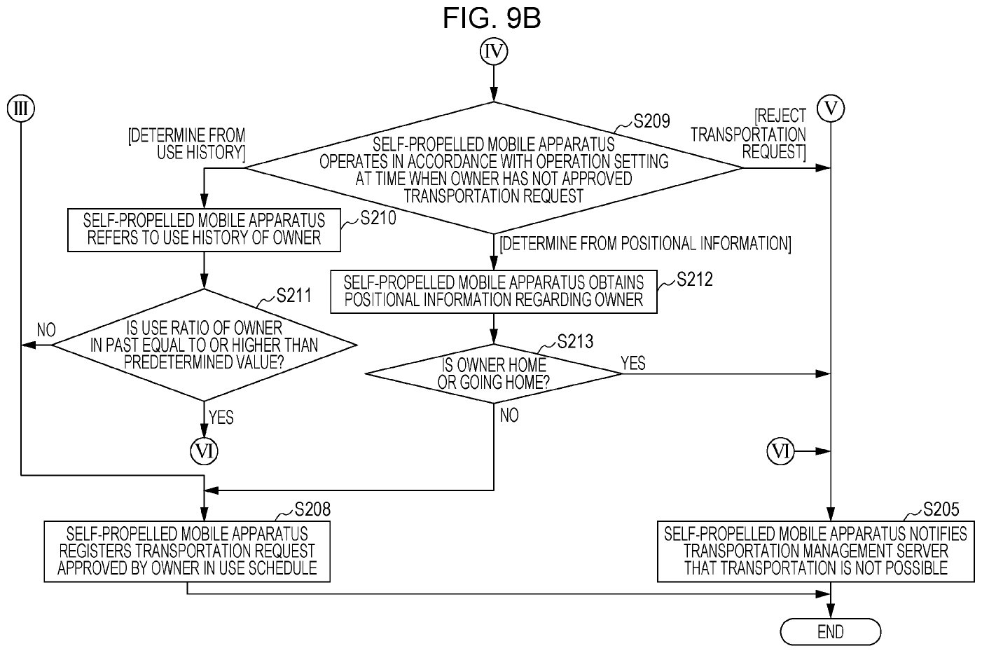

Next, processes performed when the self-propelled mobile apparatus 100 receives a transportation request will be described. FIGS. 8A and 8B are flowcharts illustrating an example of a process performed when the owner selects a transportation request. FIGS. 9A and 9B are flowcharts illustrating an example of a process performed when the transportation company specifies a transportation request.

S's in the following description refer to steps in the processes.

First, the process performed when the owner selects a transportation request will be described with reference to FIGS. 8A and 8B.

The self-propelled mobile apparatus 100 or the owner terminal 300 obtains, from the transportation management server 200, a list of requests to transport loads (S101). The list of transportation requests is displayed on the display unit 105 of the self-propelled mobile apparatus 100 or the owner terminal 300. Next, the owner selects a transportation request from the list of requests to transport loads (S102). The transportation possibility determination unit 123 then determines, on the basis of the use schedule stored in the use schedule storage unit 124 and the transportation request selected by the owner, whether transportation based on the transportation request is possible (S103).

If determining in S103 that the transportation is not possible (NO in S103), the transportation possibility determination unit 123 of the self-propelled mobile apparatus 100 notifies the owner that the transportation is not possible (S104), and the process ends. If determining in S103 that the transportation is possible (YES in S103), on the other hand, the transportation possibility determination unit 123 of the self-propelled mobile apparatus 100 notifies the owner that the transportation is possible, and transmits the transportation request selected by the owner to the transportation management server 200 (S105).

Next, the transportation company determines, using the transportation management server 200, whether to actually cause the self-propelled mobile apparatus 100 to perform the transportation based on the transportation request selected by the owner (S106). If the transportation company determines in S106 that the self-propelled mobile apparatus 100 is actually caused to perform the transportation based on the transportation request selected by the owner (YES in S106), the transportation request reception unit 122 of the self-propelled mobile apparatus 100 officially accepts the transportation request selected by the owner and transmitted from the transportation management server 200 (S107).

Next, the transportation possibility determination unit 123 of the self-propelled mobile apparatus 100 registers the transportation request selected by the owner in the use schedule of the self-propelled mobile apparatus 100 stored in the use schedule storage unit 124 (S108). As a result, the movement control unit 125 controls the self-propelled mobile apparatus 100 in such a way as to perform the transportation in accordance with the transportation request, and the process ends.

If the transportation company determines in S106 that the self-propelled mobile apparatus 100 is not actually caused to perform the transportation based on the transportation request selected by the owner (NO in S106), on the other hand, the transportation management server 200 notifies the self-propelled mobile apparatus 100 or the owner terminal 300 that the transportation request is not to be transmitted (S109), and the process ends.

Next, the process performed when the transportation company specifies a transportation request will be described with reference to FIGS. 9A and 9B.

First, the self-propelled mobile apparatus 100 or the owner terminal 300 transmits owner use conditions to the transportation management server 200 (S201). Next, the transportation company specifies a transportation request while checking time periods in which the owner will not use the self-propelled mobile apparatus 100 (S202). Next, the transportation request reception unit 122 of the self-propelled mobile apparatus 100 receives the transportation request specified by the transportation company from the transportation management server 200 (S203).

Next, the transportation possibility determination unit 123 of the self-propelled mobile apparatus 100 determines, on the basis of the use schedule stored in the use schedule storage unit 124 and the transportation request received by the transportation request reception unit 122, whether transportation based on the transportation request is possible (S204). If determining in S204 that the transportation is not possible (NO in S204), the transportation possibility determination unit 123 of the self-propelled mobile apparatus 100 notifies the transportation management server 200 that the transportation is not possible (S205), and the process ends. If determining in S204 that the transportation is possible (YES in S204), the transportation possibility determination unit 123 of the self-propelled mobile apparatus 100 notifies the owner that the transportation is possible, and asks the owner to approve the transportation request (S206).

Next, the transportation possibility determination unit 123 of the self-propelled mobile apparatus 100 determines whether the owner has approved the transportation request within the certain period of time (S207). If so (YES in S207), the transportation possibility determination unit 123 registers the transportation request approved by the owner in the use schedule of the self-propelled mobile apparatus 100 stored in the use schedule storage unit 124 (S208). As a result of the registration of the transportation request in the use schedule, the movement control unit 125 controls the self-propelled mobile apparatus 100 in such a way as to perform the transportation in accordance with the transportation request.

If not (NO in S207), on the other hand, the self-propelled mobile apparatus 100 operates in accordance with the operation setting at a time when the owner has not approved a transportation request (S209).

If the operation setting is the setting for rejecting a transportation request in S209, the transportation possibility determination unit 123 determines that the transportation is not possible, and the process proceeds to S205.

If the operation setting is the setting for making a determination from the owner's use history in S209, the transportation possibility determination unit 123 of the self-propelled mobile apparatus 100 refers to the owner's use history (S210). Next, the transportation possibility determination unit 123 determines whether the use ratio of the self-propelled mobile apparatus 100 by the owner at times related to a time specified by the transportation request is equal to or higher than the certain value (S211). If not (NO in S211), the process proceeds to S208. Although the owner has not approved the transportation request, the transportation request is registered in the use schedule. If so (YES in S211), on the other hand, the process proceeds to S205.

If the operation setting is the setting for making a determination from the positional information regarding the user in S209, the transportation possibility determination unit 123 of the self-propelled mobile apparatus 100 obtains the positional information regarding the owner (S212). It is assumed in this example that the owner's home is set as the position of the owner at a time when the owner uses the self-propelled mobile apparatus 100. In this case, the transportation possibility determination unit 123 of the self-propelled mobile apparatus 100 determines whether the owner is home or going home (S213). If the owner is home or going home (YES in S213), the transportation possibility determination unit 123 determines that the transportation is not possible, and the process proceeds to S205. If the owner is not home or going home (NO in S213), the transportation possibility determination unit 123 determines that the transportation is possible, and the process proceeds to S208. Although the owner has not approved the transportation request, the transportation request is registered in the use schedule.

Process Performed when Transportation is Canceled

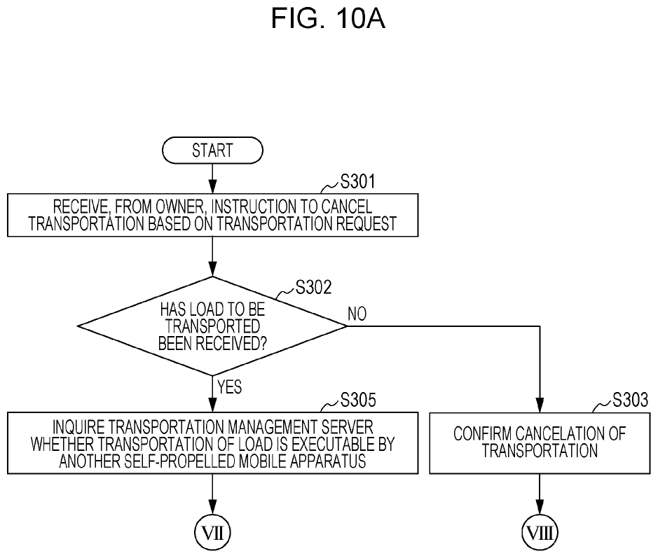

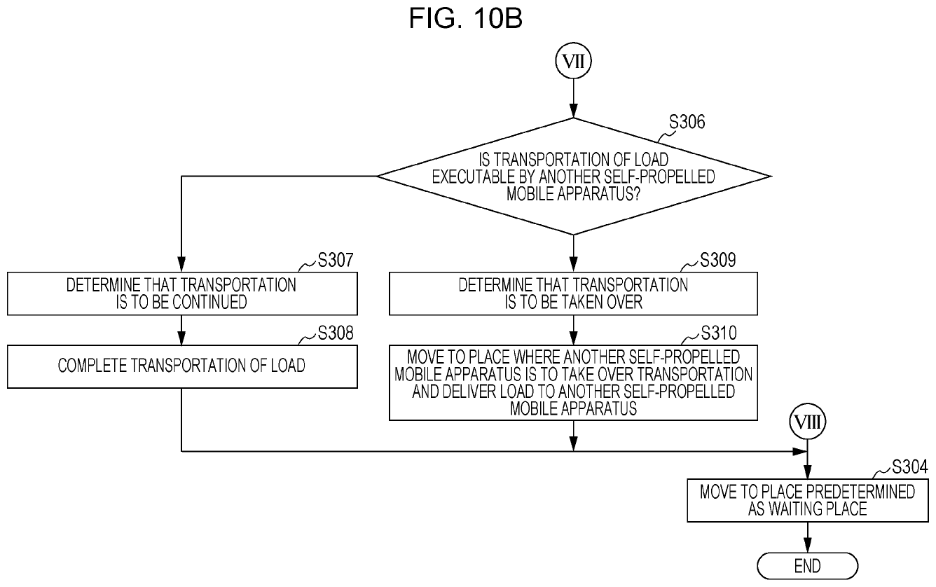

Next, a process performed when the owner cancels transportation performed by the self-propelled mobile apparatus 100 will be described. FIGS. 10A and 10B are flowcharts illustrating an example of the process performed when the owner cancels transportation performed by the self-propelled mobile apparatus 100.

First, the transportation possibility determination unit 123 of the self-propelled mobile apparatus 100 receives, from the owner, an instruction to cancel transportation based on a transportation request (S301). Next, the transportation possibility determination unit 123 determines whether a load to be transported has been received (S302). If not (NO in S302), the transportation possibility determination unit 123 confirms the cancellation (S303). The self-propelled mobile apparatus 100 notifies the owner terminal 300 and the transportation management server 200 of the cancellation of the transportation. Next, the self-propelled mobile apparatus 100 moves to the place predetermined as the waiting place (e.g., the owner's home) (S304), and the process ends.

If so (YES in S302), on the other hand, the transportation possibility determination unit 123 inquires the transportation management server 200 whether the transportation of the load is executable by another self-propelled mobile apparatus (S305). Next, the transportation possibility determination unit 123 determines, on the basis of a result of the inquiry to the transportation management server 200, whether the transportation of the load is executable by another self-propelled mobile apparatus (S306). If not (NO in S306), the transportation possibility determination unit 123 determines that the transportation is to be continued (S307). The self-propelled mobile apparatus 100 then completes the transportation of the load (S308). The process proceeds to S304.

If so (YES in S306), on the other hand, the transportation possibility determination unit 123 determines that the transportation is to be taken over (S309). The self-propelled mobile apparatus 100 moves to a place where the transportation of the load is to be taken over and delivers the load to the other self-propelled mobile apparatus 100 (S310). The process then proceeds to S304.

In the present exemplary embodiment, the self-propelled mobile apparatus 100 might run out of battery during movement. In this case, another self-propelled mobile apparatus 100 for charging may be dispatched to the self-propelled mobile apparatus 100. For example, the other self-propelled mobile apparatus 100 for charging or the owner terminal 300 regularly communicates with the self-propelled mobile apparatus 100 to track the remaining amount of battery of the self-propelled mobile apparatus 100. If the remaining amount of battery decreases to a predetermined threshold, the self-propelled mobile apparatus 100 requests the transportation management server 200 to dispatch the other self-propelled mobile apparatus 100 for charging. Upon receiving the request from the self-propelled mobile apparatus 100 or the owner terminal 300, the transportation management server 200 dispatches the other self-propelled mobile apparatus 100 for charging to a place where the self-propelled mobile apparatus 100 is located.

Alternatively, the transportation management server 200 may track the remaining amount of battery of each self-propelled mobile apparatus 100. In this case, if the transportation management server 200 detects a self-propelled mobile apparatus 100 whose remaining amount of battery has decreased to the predetermined threshold, the transportation management server 200 dispatches the self-propelled mobile apparatus 100 for charging to a place where the self-propelled mobile apparatus 100 is located.

Furthermore, in the present exemplary embodiment, the self-propelled mobile apparatus 100 might break down during movement. In this case, an alternative self-propelled mobile apparatus 100 may be dispatched to the self-propelled mobile apparatus 100 that has broken down. For example, the owner terminal 300 regularly receives a notification from the self-propelled mobile apparatus 100 and, if no notification has been received for a certain period of time, the owner terminal 300 requests the transportation management server 200 to dispatch an alternative self-propelled mobile apparatus 100. Upon receiving the request, the owner terminal 300 dispatches an alternative self-propelled mobile apparatus 100 to a place where the self-propelled mobile apparatus 100 that has broken down is located.

Alternatively, the transportation management server 200 may regularly receive a notification from each self-propelled mobile apparatus 100. In this case, if the transportation management server 200 detects a self-propelled mobile apparatus 100 from which no notification has been received for the certain period of time, the transportation management server 200 dispatches an alternative self-propelled mobile apparatus 100 to a place where the self-propelled mobile apparatus 100 is located.

In addition, the transportation management server 200 may dispatch a self-propelled mobile apparatus 100 for retrieving a self-propelled mobile apparatus 100 that has broken down along with an alternative self-propelled mobile apparatus 100.

As described above, the self-propelled mobile apparatus 100 obtains owner use conditions as use conditions for the owner set by the owner. The owner use conditions include a scheduled start time and a scheduled start place. If owner use conditions are set, the self-propelled mobile apparatus 100 receives transportation requests from persons other than the owner while giving priority to the set owner use conditions. More specifically, the self-propelled mobile apparatus 100 determines whether a transportation request would present use of the self-propelled mobile apparatus 100 at a scheduled start place from a scheduled start time. The self-propelled mobile apparatus 100 determines that execution of transportation based on a transportation request that would prevent scheduled use of the self-propelled mobile apparatus 100 from taking place at a scheduled start place from a scheduled start time is not possible, and does not perform the transportation. The self-propelled mobile apparatus 100 determines, on the other hand, that execution of transportation based on a transportation request that would not prevent scheduled use of the self-propelled mobile apparatus 100 from taking place at a scheduled start place from a scheduled start time is possible, and performs the transportation.

In the present exemplary embodiment, the transportation possibility determination unit 123 may determine whether transportation based on a transportation request is possible while taking into consideration the performance of the self-propelled mobile apparatus 100. Depending on the storage capacity of the self-propelled mobile apparatus 100, for example, it might be difficult to transport a certain kind of load. Such a load is not suitable for transportation because of the performance of the self-propelled mobile apparatus 100. For this reason, first, the transportation possibility determination unit 123 determines, on the basis of the performance of the self-propelled mobile apparatus 100, whether transportation based on a transportation request is possible. If determining that the transportation is possible, the transportation possibility determination unit 123 also determines whether execution of the transportation based on the transportation request would prevent scheduled use of the self-propelled mobile apparatus 100 from taking place at a scheduled start place from a scheduled start time.

More specifically, for example, the transportation possibility determination unit 123 determines whether a load to be transported can be stored in the self-propelled mobile apparatus 100. If the load can be stored in the self-propelled mobile apparatus 100, the transportation possibility determination unit 123 determines whether execution of the transportation of the load would prevent scheduled use of the self-propelled mobile apparatus 100 from taking place at a scheduled start place from a scheduled start time.

In the above example, if the transportation possibility determination unit 123 determines that transportation is possible after the transportation company specifies a transportation request, the owner is asked to approve the transportation request and, if the owner has not approved the transportation request within the certain period of time, whether the transportation is possible is determined on the basis of the owner's use history and the positional information regarding the owner. Whether transportation is possible, however, need not be determined on the basis of the owner's use history and the positional information regarding the owner in this manner.

If the transportation company specifies a transportation request and the transportation possibility determination unit 123 determines that transportation is possible, for example, whether the transportation is possible may be determined on the basis of the owner's use history and the positional information regarding the owner without asking the owner to approve the transportation request, instead. In addition, if the transportation possibility determination unit 123 determines transportation is possible after the owner selects a transportation request from a list of transportation requests transmitted from the transportation management server 200, for example, whether the transportation is possible may be determined on the basis of the owner's use history and the positional information regarding the owner, instead. In this case, if the use ratio of self-propelled mobile apparatus 100 by the owner is high in the past on the same day in the same time period, for example, the transportation possibility determination unit 123 determines that the transportation is not possible, even if the owner has selected a transportation request. A notification for checking whether to perform the transportation or a notification for recommending the owner not to perform the transportation, for example, is then transmitted to the owner.

In the present exemplary embodiment, the owner of the self-propelled mobile apparatus 100 has a right to use the self-propelled mobile apparatus 100 preferentially. A person who has a right to use the self-propelled mobile apparatus 100 preferentially, however, is not limited to the owner of the self-propelled mobile apparatus 100. Anyone who has been given a right to use the self-propelled mobile apparatus 100 preferentially may use the self-propelled mobile apparatus 100 preferentially.

In the present exemplary embodiment, the transportation management server 200 and/or the owner terminal 300 may achieve some or all of the functions of the owner use condition obtaining unit 121, the transportation request reception unit 122, the transportation possibility determination unit 123, the use schedule storage unit 124, the movement control unit 125, and the display control unit 126 illustrated in FIG. 4, instead. More specifically, if the owner terminal 300 achieves the functional units, namely the owner use condition obtaining unit 121, the transportation request reception unit 122, the transportation possibility determination unit 123, the movement control unit 125, and the display control unit 126, for example, the owner terminal 300 may be regarded as an example of the information processing system. If the self-propelled mobile apparatus 100 and the owner terminal 300 achieve these functional units, the self-propelled mobile apparatus 100 and the owner terminal 300 may be regarded as an example of the information processing system. Furthermore, if the self-propelled mobile apparatus 100, the transportation management server 200, and the owner terminal 300 achieve these functional units, the self-propelled mobile apparatus 100, the transportation management server 200, and the owner terminal 300 may be regarded as an example of the information processing system.

A program for achieving the exemplary embodiment of the present disclosure may be provided through a communication medium or in a storage medium such as a compact disc read-only memory (CD-ROM).

Although the exemplary embodiment and the modifications have been described above, the exemplary embodiment and the modifications may be combined with each other.

The present disclosure is not limited to the above exemplary embodiment and may be implemented in various manners without deviating from the scope of the present disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
an obtaining unit that obtains settings of a scheduled time and a scheduled place at which a first user is to use the self-propelled mobile apparatus, the scheduled time and the scheduled place being set by the first user;
a reception unit that receives at least one instruction of a movement for the self-propelled mobile apparatus, the at least one instruction being given by a second user; and
a control unit that, if execution of the instructed movement would prevent the scheduled use of the self-propelled mobile apparatus from taking place at the scheduled place from the scheduled time, causes the self-propelled mobile apparatus not to execute the instructed movement.

2. The information processing system according to claim 1,
wherein, if execution of the instructed movement by the self-propelled mobile apparatus would prevent the self-propelled mobile apparatus from arriving at the scheduled place by the scheduled time, the control unit causes the self-propelled mobile apparatus not to execute the instructed movement.

3. The information processing system according to claim 1,
wherein whether the control unit causes the self-propelled mobile apparatus to execute the instructed movement is further based on a use history of the self-propelled mobile apparatus by the first user.

4. The information processing system according to claim 3,
wherein the instruction received by the reception unit specifies a time at which the movement is to be executed, and if the use history indicates that a use ratio of the self-propelled mobile apparatus by the first user at times related to the specified time is equal to or higher than a predetermined value, the control unit causes the self-propelled mobile apparatus not to execute the instructed movement.

5. The information processing system according to claim 1,
wherein whether the control unit causes the self-propelled mobile apparatus to execute the instructed movement is further based on positional information regarding the first user.

6. The information processing system according to claim 5,
wherein, if the positional information indicates that the first user is moving to a predetermined place at a time of the reception of the at least one instruction by the reception unit, the control unit causes the self-propelled mobile apparatus not to execute the instructed movement.

7. The information processing system according to claim 5,
wherein, the positional information indicates that if execution of the instructed movement by the self-propelled mobile apparatus would prevent the self-propelled mobile apparatus from arriving at a predetermined place before arrival of the first user at the predetermined place, the control unit causes the self-propelled mobile apparatus not to execute the instructed movement.

8. The information processing system according to claim 1, further comprising:
a display unit that displays information regarding whether the instructed movement is executable by the self-propelled mobile apparatus.

9. The information processing system according to claim 8,
wherein the display unit displays a time period in which the instructed movement is executable by the self-propelled mobile apparatus.

10. The information processing system according to claim 8,
wherein the at least one instruction includes a plurality of instructions and the display unit displays the plurality of instructions in such a manner that any instruction instructing a movement executable by the self-propelled mobile apparatus and any instruction instructing a movement unexecutable by the self-propelled mobile apparatus are differentiated from each other.

11. The information processing system according to claim 1,
wherein the instruction instructs transportation of an object or a person, the reception unit receives a request for cancellation of the instructed transportation from the first user, and the control unit confirms the requested cancellation if the cancellation is request before the object or the person is loaded onto the self-propelled mobile apparatus and rejects the requested cancellation if the cancellation is requested after the object or the person has been loaded onto the self-propelled mobile apparatus.

12. The information processing system according to claim 11,
wherein, if the instructed transportation is executable by another self-propelled mobile apparatus, the control unit confirms the requested cancellation even after the object or the person has been loaded onto the self-propelled mobile apparatus.

13. An information processing system comprising:
a reception unit that receives at least one instruction of movement for a self-propelled mobile apparatus with a schedule of use the self-propelled mobile apparatus by a first user set, the at least one instruction being given by a second user; and
an obtaining unit that obtains settings of a schedule time and a schedule place at which the first user is to use the self-propelled mobile apparatus as conditions for determining whether the self-propelled mobile apparatus is to execute the movement instructed by the instruction received by the reception unit.

14. A self-propelled mobile apparatus comprising:
an obtaining unit that obtains settings of a scheduled time and a scheduled place at which a first user is to use the self-propelled mobile apparatus, the scheduled time and the scheduled place being set by the first user;
a reception unit that receives at least one instruction of a movement for the self-propelled mobile apparatus, the at least one instruction being given by a second user;
a movement unit that achieves the instructed movement; and
a control unit that, if execution of the instructed movement would prevent the scheduled use of the self-propelled mobile apparatus from taking place at the scheduled place from the scheduled time, causes the movement unit not to execute the instructed movement.
